(19) United States
(12) Patent Application Publication
(10) Pub. No.: US 2006/0285597 A1
(43) Pub. Date: Dec. 21, 2006

(54) Reusing interpolated values in advanced video encoders

(75) Inventors: Pallapothu Shyam Sundera Bala Koteswara Gupta, Bangalore (IN); Kopparapu Suman, Bangalore (IN); Raghu Tippuru SrikanthaRao, Bangalore (IN); Korada Ramkishor, Bangalore (IN)

Correspondence Address: Robert E. Krebs;THELEN REID & PRIEST LLP, P.O. Box 640640, San Jose, CA, 95164-0640, US

(73) Assignee: Flextronics International USA, Inc.

(21) Appl. No.: 11/157,319

(22) Filed: Jun. 20, 2005

(51) Int. Cl. H04N 11/04; H04N 7/12; H04B 1/66; H04N 11/02

(52) U.S. Cl. 375/240.17; 375/240.12

(57) ABSTRACT

The fact that fractional-pixel points that are searched are close to each other, and hence the half-pixel and quarter-pixel interpolation of each point involves computing interpolations that have already been computed, may be exploited. This is accomplished by storing the interpolated values of the first point and reusing them when computing the interpolations for the other points. This may be performed for both horizontal and vertical interpolations. For interpolation in both the horizontal and vertical directions, the horizontal interpolated values may be reused, and vertical interpolation carried out over them, or vice-versa. For computing the quarter-pixel interpolated values, the half-pixel interpolated values computed and stored previously may be used.

### FIELD OF THE INVENTION

The present invention relates to video compression. More particularly, the present invention relates to the reuse of interpolated values in advanced video encoders.

### BACKGROUND OF THE INVENTION

Video compression is utilized by many computer and electronic components to reduce the size of digital transmissions. By compressing out redundant or unnecessary information in a video stream, the bandwidth utilized by the stream can be greatly reduced.

A commonly used video compression standard is the MPEG-4 standard. The MPEG-4 standard contains a number of different tool sets and codecs, two of the more popular ones being Advanced Simple Profile and MPEG-4 part 10. These and other MPEG tools can involve the use of motion estimation. Motion estimation capitalizes on the fact that, within a short sequence of the same general image, most objects remain in the same location, while others move only a short distance. The motion may be described as a two-dimensional motion vector that specifies where to retrieve a macroblock from a previously decoded frame in order to predict the sample values of the current macroblock. A macroblock is a grouping of pixels (most commonly a 16×16 grouping) within the overall image. Motion estimation is performed at the macroblock or sub-macroblock level.

In older versions of MPEG, integer pixel motion estimation was utilized. Here, the accuracy of the estimation was limited to integers, thus the minimum amount an object could be estimated to move would be one whole pixel. In practice, however, sub-pixel movements of objects may occur in an image. For example, an object on a screen may only move a half, or even a quarter pixel to the right. Integer pixel motion estimation is not accurate enough to compensate for such small movements.

In light of this inaccuracy, half-pixel estimation was introduced. In half-pixel estimation, movements of a half a pixel or more are estimated through the use of interpolation. This is also known as half-pel interpolation. Since there are 8 positions that are either vertically or horizontally (or both) exactly half a pixel away from a given integer coordinate, values for these 8 positions may be estimated, and then these estimates may be compared with a sample taken from the subsequent frame. The position that comes the closest to the sample is chosen as the likely new position for the object. While this improves the accuracy of the estimation, and thus provides for more effective motion compensation, it also adds a layer of complexity to the process, and thus can slow down processing. As processors have gotten more powerful, however, such drawbacks can be more easily overlooked, and in fact half-pel interpolation has become quite common, made even more accurate through the use of high order filters (which also add processor overhead).

MPEG-4 took this a step further and introduced quarter-pixel estimation. In quarter-pixel estimation, movements of a quarter pixel or more are estimated through the use of interpolation. This is also known as quarter-pel interpolation. All this, however, creates a huge amount of additional computations, and renders the quarter-pixel motion vector search a bottleneck in terms of the performance of the video codec.

In the past, this problem has been dealt with by reducing the number of macroblocks for which quarter-pixel search is performed, or by performing an approximate quarter-pixel search utilizing early exit conditions. Typically, around a given integer-pixel motion vector, there are 8 half-pixel points and 40 quarter-pixel points that are to be evaluated. Since performing half-pixel and quarter-pixel interpolations for each of these points would be unfeasible for any real-time video codec, a subset of these points is picked and only those points are evaluated. The search is generally performed using a hierarchical procedure where half-pixel points are first evaluated and only those quarter-pixel points which lie around the “best” half-pixel point are searched. This would involve searching around 6 to 8 half pixel points and another 6 to 8 quarter pixel points. It should be noted here that the quarter-pixel filtering specified in the standard may or may not use the half-pixel interpolated values. However, since the standards do not impose a direct restriction on the search mechanism, one can always use half-pixel interpolate values for computing the quarter-pixel interpolated values while performing quarter-pixel search to make use of the current invention.

Another prior technique is to speed up half-pel estimation by recognizing that the degrees of resemblance between data samples and interpolations will eventually need to be computed anyway, and thus the overall number of computations can be reduced if the two steps can be combined to share computations. For example, if an integer position is (0,0), then interpolation of the half-pixel to the right of this position would require computing the estimated value for (0,0) and the estimated value for (0,1) and then interpolating between them (adding them up and dividing by two). Then a second step where this interpolated value is subtracted from a data sample would be computed. However, the technique that combines these two steps allows the initial computation of the data sample minus the portion of the estimate half-pixel value arising from the (0,0) pixel. Since that computation would then be repeated for the half-pixels to the left, above, and below the (0,0) position, what would have been 4 computations can be reduced to 1.

These prior art solutions do reduce the performance overhead of the half-pixel and/or quarter-pixel search algorithms, but the quarter-pixel search algorithm still represents a bottleneck in terms of speed, and thus has not really been commonly adopted. What is needed is a solution that can further reduce the performance overhead of the quarter-pixel search algorithm without reducing its effectiveness.

### BRIEF DESCRIPTION OF THE INVENTION

The fact that fractional-pixel points that are searched are close to each other, and hence the half-pixel and quarter-pixel interpolation of each point involves computing interpolations that have already been computed, may be exploited. This is accomplished by storing the interpolated values of the first point and reusing them when computing the interpolations for the other points. This may be performed for both horizontal and vertical interpolations. For interpolation in both the horizontal and vertical directions, the horizontal interpolated values may be reused, and vertical interpolation carried out over them, or vice-versa. For computing the quarter-pixel interpolated values, the half-pixel interpolated values computed and stored previously may be used.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a diagram illustrating an order for fractional-pixel motion estimation in accordance with an embodiment of the present invention.

FIG. 2 is a flow diagram illustrating a method for performing motion estimation around a first point in an image in a video stream in accordance with an embodiment of the present invention.

FIG. 3 is a flow diagram illustrating a method for performing motion estimation around a first integer point in an image in a video stream in accordance with another embodiment of the present invention.

FIG. 4 is a flow diagram illustrating finding a best half-pixel estimate point for a first integer point in accordance with an embodiment of the present invention.

FIG. 5 is a flow diagram illustrating finding a best quarter-pixel estimate point for a half-pixel estimate point in accordance with an embodiment of the present invention.

FIG. 6 is a block diagram illustrating an apparatus for performing motion estimation around a first point in an image in a video stream in accordance with an embodiment of the present invention.

FIG. 7 is a block diagram illustrating an apparatus for performing motion estimation around a first integer point in an image in a video stream in accordance with another embodiment of the present invention.

FIG. 8 is a block diagram illustrating a best half-pixel estimate point finder in accordance with an embodiment of the present invention.

FIG. 9 is a block diagram illustrating a best quarter-pixel estimate point finder in accordance with an embodiment of the present invention.

### DETAILED DESCRIPTION

Embodiments of the present invention are described herein in the context of reusing interpolated values for video encoding. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

The present invention exploits the fact that fractional-pixel points that are searched are close to each other, and hence the half-pixel and quarter-pixel interpolation of a block at each point involves computing interpolations that have already been computed. This is accomplished by storing the interpolated values of the block corresponding to the first point and reusing them when computing the interpolations for blocks corresponding to other points. This may be performed for both horizontal and vertical interpolations. For interpolation in both the horizontal and vertical directions, the horizontal interpolated values may be reused, and vertical interpolation carried out over them. For computing the quarter-pixel interpolated values, the half-pixel interpolated values computed and stored previously may be used. For ease of reading, from this point on this document, the terms “evaluating a point” or “computing the interpolated values at a point” are used to indicate that a block of values is computed starting from that point.

The present invention is based on the fact that all the fractional-pixel points that are evaluated are within an integer-pixel distance from the best integer-pixel point. Hence the number of half-pixel interpolations required for fractional-pixel search need not be significantly high. Once the horizontal and vertical interpolated values are computed for any point, they may be stored and reused for all the other points. The number of additional calculations needed for the interpolation of every new search point can thus be reduced significantly.

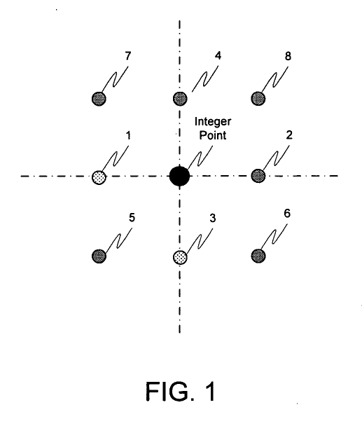

In an embodiment of the present invention, a hierarchical method is used for quarter-pixel searching. In other words, the best half-pixel position is first computed and then the best quarter-pixel position is found out. It should be noted that one of ordinary skill in the art would recognize that the present invention need not be carried out in hierarchical fashion, and that the hierarchical method is merely one embodiment of the present invention. The search may start with the half-pixel point to the left of the integer-pixel point. The interpolated values computed there may be stored. Then the interpolated values for the half-pixel point to the right of the integer-pixel point may be computed. Then below, and then above. FIG. 1 is a diagram illustrating an order for fractional-pixel motion estimation in accordance with an embodiment of the present invention. Here, the reference numerals represent the order in which the points may be interpolated, thus point 1 may be computed first, followed by point 2, point 3, and so on. One of ordinary skill in the art will recognize that this order may be modified to any desired order and the present invention would still be useful as long as some of the interpolated values are reused.

In light of this, the most likely points to reuse prior calculated interpolated values will be points that require interpolation in both the horizontal and vertical directions. Therefore, it is beneficial to compute these after computing the points that require interpolation in the horizontal only and/or vertical only directions. Thus, after points 1, 2, 3, and 4 have been calculated, the stored interpolated values may be reused when computing interpolated values for points 5, 6, 7, and 8. The points which could reuse the stored interpolated values are indicated in bold.

As can also be seen, the second horizontal only direction and vertical only direction points can also reuse the stored interpolated values. Thus, points 2 and 4 are also in bold.

After these points have been computed, the best half-pixel position may be determined. Then the quarter-pixel positions around this half-pixel position may be computed. The ordering of these quarter-pixel positions may be the same as for the half-pixel positions, although it is not strictly necessary. Once again, it is simply more beneficial to compute the interpolated values for points requiring interpolation in both the horizontal and vertical directions after the points that require interpolation in the horizontal only and/or vertical only directions, so that the interpolations may be reused.

More to the point, however, the half-pixel interpolated values have been saved, and thus can be re-used during the quarter-pixel interpolation. This may be done in conjunction with, or even in lieu of, saving the quarter-pixel interpolated values for reuse.

One of ordinary skill in the art will also recognize that the reuse of interpolated values may occur to any depth of the calculations that the user wishes to perform. Thus, the invention could be applied in the future to ⅛-pixel motion estimation, 1/16-pixel motion estimation, etc.

In an embodiment of the present invention, in half-pixel motion vector calculation, 8 half pixel points are evaluated. Of these, 4 have half-pixel displacement in only one direction and the other 4 have half-pixel displacement in both directions. For the first 4 points (the one-direction half-pixel), 4 times the block size filter computations are required if the present invention is not utilized. If the present invention is utilized, however, that may be reduced to only 2 times the block size filter computations, as approximately all the computations may be saved for the second horizontal and vertical points due to reuse.

For the remaining 4 points (both directions half pixel), 8 times the block size filter computations are required if the present invention is not utilized. If the present invention is utilized, however, that may be reduced to only 1 times the block size filter computations, since the horizontal interpolated values are all available and the both directions half-pixel interpolations performed for one point can be reused for the other three points.

For the half-pixel computations required for quarter-pixel searches around the best half-pixel point, the estimation of the number of computations required can vary based on the half-pixel position chosen as the best. There are four different cases. Note that in all the four cases below, only the half-pixel interpolation operations required for obtaining the quarter-pixel interpolated values are estimated. However, the quarter-pixel interpolations themselves could also be reused to save on the operations required for performing the quarter-pixel filtering.

In the first case, the integer-pixel position is the best. Assuming equal probabilities for all the 9 positions, the probability of this happening is 1/9. In this case, of the 8 quarter-pixel points to be searched, 4 will have quarter-pixel displacement in one direction and integer-pixel values in the other direction. The other 4 will have quarter-pixel displacement in both directions. Among the first four, two will have quarter-pixel displacement in only the x-direction and 2 will have quarter-pixel displacement in only the y-direction. If the half-pixel interpolations are not reused, then 12 times the block size half-pixel filter operations need to be performed (4 times block size operations for the first set and 8 times block size operations for the second set). If, however, the half-pixel interpolations are reused, no additional half-pixel interpolations need to be performed as all the half-pixel interpolated values required are already computed and stored in memory during the half-pixel search.

In the second case, a half-pixel point in the only-x direction is best. The probability of this happening is 2/9. In this case, of the 8 quarter-pixel points to be searched, 2 will have quarter-pixel displacement in the x-direction and integer pixel values in the y-direction, 2 will have quarter-pixel displacement in the y-direction and half pixel values in the x-direction, and the other 4 will have quarter-pixel displacement in both directions. If the half-pixel interpolations are not reused, then 2 times block size half-pixel computations are required for the two points which have quarter-pixel displacement only in the x-direction, 4 times block size half-pixel computations are required for the two points that have quarter-pixel displacements in the y direction and half pixel displacement in the x-direction, and 8 times block size half-pixel computations are required for the four points that have quarter-pixel displacements in both the directions, a total of 14 times block size half-pixel computations. When the interpolated values are reused, all these calculations can be saved since the interpolated values are already available from the half-pixel search iteration.,

In the third case, a half-pixel point in only the y-direction is best. The probability of this happening is 2/9. In this case, of the 8 quarter-pixel points to be search, 2 will have quarter-pixel displacement in the y-direction and integer-pixel values in the x-direction, 2 will have quarter-pixel displacement in the x-direction and half-pixel displacement in the y-direction, and the other 4 will have quarter-pixel displacement in both directions. When interpolated values are not reused, 2 times block size half-pixel computations are required for the 2 points that have quarter-pixel displacement only in the y-direction, 4 times block size half-pixel computations are required for the 2 points that have quarter-pixel displacement in only the x-direction and half-pixel displacement in the y-direction, and 8 times block size computations are required for the 4 points that have quarter-pixel displacements in both the direction, a total of 14 times block size half-pixel computations. When the interpolated values are reused, again, no additional half-pixel computations are performed.

In the fourth case, a half-pixel point displaced in both the x and y directions is best. The probability of this occurring is 4/9. Here, for all the points, half-pixel interpolation needs to be done in both the directions. So 16 times block size computations are required if half-pixel values are not reused. If half-pixel values are reused, all these computations can be saved.

Overall then, without reuse of interpolated values, the average number of operations is (12+(12*1/9)+(14*2/9)+(14*2/9)+(16*4/9))*Block size, or 240/9 times block size operations. With half-pixel reuse, it is 3*Block size operations. Therefore, the average savings for a quarter-pixel search per block is 88.75%.

It should be noted that throughout this document, a description of a point being a fraction of a pixel “away from” another point will be utilized. The term “away from” should be interpreted in light of the fact that when fractions of a pixel are estimated, the two points are represented by values being rounded off to the fraction of a pixel. Thus, a point may be labeled as being a fraction of a pixel away from another point if its x-coordinate, y-coordinate, or both is/are that fraction of a pixel away from the other point. This may or may not correspond directly with the precise distance between the two points should a direct line be drawn between the two. For example, a coordinate (0.5, 0.5) will be considered to be a half a pixel away from a point (0,0) for purposes of this document, even though geometrically speaking the distance would actually be the square root of 0.5. Since applicant is allowed to be his own lexicographer, the term “away from” shall be interpreted in the claims to mean that the point has an x-coordinate, y-coordinate, or both that is/are that distance away from the x-coordinate and y-coordinate of the other point.

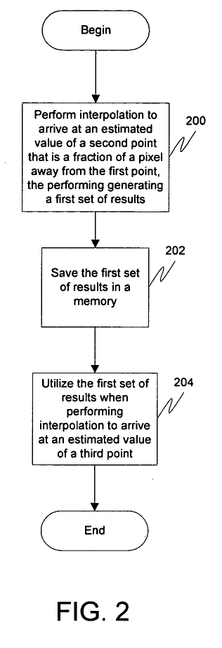

FIG. 2 is a flow diagram illustrating a method for performing motion estimation around a first point in an image in a video stream in accordance with an embodiment of the present invention. It should be noted that this method may be performed around any point in the image. Each act of this method may be performed by software, hardware, or any combination thereof. At 200, interpolation may be performed to arrive at an estimated value of a second point that is a fraction of a pixel away from the first point, the performing generating a first set of results. The fraction of the pixel may be any fraction, and as discussed earlier, being a fraction of a pixel away from a point means that either the horizontal coordinate, vertical coordinate, or both vary from the point by the fraction.

At 202, the first set of results may be saved in a memory. At 204, the first set of results may be utilized when performing interpolation to arrive at an estimated value of a third point. This utilization may occur at many different stages. For example, the third point may vary from the first point by the same fraction as the second point. Alternatively, the third point may vary a different point by the same fraction as the second point. Another possibility is that the third point may vary from either the first point or another point by a different fraction than the second point varied from the first point.

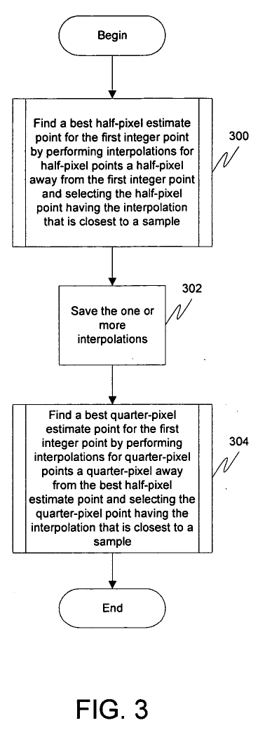

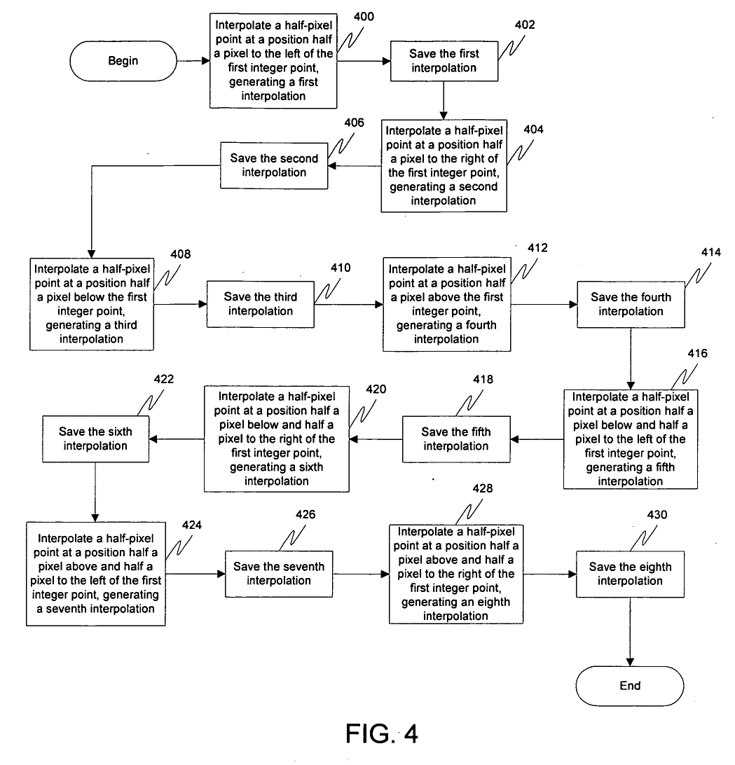

FIG. 3 is a flow diagram illustrating a method for performing motion estimation around a first integer point in an image in a video stream in accordance with another embodiment of the present invention. Each act of this method may be performed by software, hardware, or any combination thereof. In this embodiment, first half-pixel estimation is performed, followed by quarter-pixel estimation on the best half-pixel estimate point. Thus, at 300, a best half-pixel estimate point around the first integer point may be found by performing interpolations for half-pixel points a half-pixel away from the first integer point and selecting the half-pixel point having the interpolation that is closest to a sample. At 302, one or more of the interpolations may be saved. It should be noted that this saving may actually be performed during the finding of a best half-pixel estimate point, as will be seen in FIG. 4 and the accompanying text. Saving one or more of the interpolations during the finding allows the interpolations to be reused during other parts of the finding a best half-pixel estimate point. However, embodiments are possible where the interpolations from the finding of the half-pixel estimate point are not re-used during the finding of the half-pixel estimate point, and are only re-used during the finding of the best quarter-pixel estimate point.

At 304, a best quarter-pixel estimate point may be found for the best half-pixel estimate point by performing interpolations for quarter-pixel points a quarter-pixel away from the best half-pixel estimate point and selecting the quarter-pixel point having the interpolation that is closest to sample. This may include utilizing the one or more saved interpolations from the half-pixel estimation and/or one or more saved interpolations during the finding of the best quarter-pixel estimate point.

FIG. 4 is a flow diagram illustrating finding a best half-pixel estimate point for a first integer point in accordance with an embodiment of the present invention. FIG. 4 represents 300 of FIG. 3 in more detail. Each act of the method may be performed in hardware, software, or any combination thereof. Additionally, the ordering of the acts may be varied depending upon the implementation. Furthermore, it is not strictly necessary to save each interpolation, as the system may not need or want to re-use all of them. Lastly, one or more of the interpolations saved during this method can be re-used during other acts in the method, in addition to being able to be reused in subsequent methods.

At 400, a half-pixel point at a position half a pixel to the left of the first integer point may be interpolated, generating a first interpolation. At 402, the first interpolation may be saved. At 404, a half-pixel point at a position half a pixel to the right of the first integer point may be interpolated, generating a second interpolation. At 406, the second interpolation may be saved. At 408, a half-pixel point at a position half a pixel below the first integer point may be interpolated, generating a third interpolation. At 410, the third interpolation may be saved. At 412, a half-pixel point at a position half a pixel above the first integer point may be interpolated, generating a fourth interpolation. At 414, the fourth interpolation may be saved.

At 416, a half-pixel point at a position half a pixel below and half a pixel to the left of the first integer point may be interpolated, generating a fifth interpolation. At 418, the fifth interpolation may be saved. At 420, a half-pixel point at a position half a pixel below and half a pixel to the right of the first integer point may be interpolated, generating a sixth interpolation. At 422, the sixth interpolation may be saved. At 424, a half-pixel point at a position half a pixel above and half a pixel to the left of the first integer point may be interpolated, generating a seventh interpolation. At 426, the seventh interpolation may be saved. At 428, a half-pixel point at a position half a pixel above and half a pixel to the right of the first integer point may be interpolated, generating an eighth interpolation. At 430, the eighth interpolation may be saved.

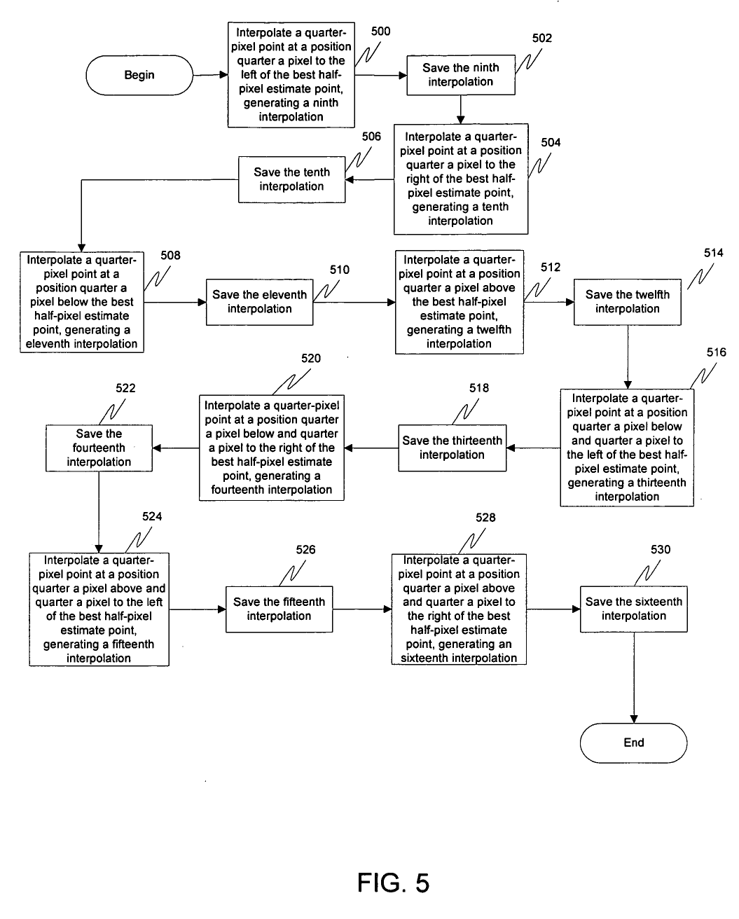

FIG. 5 is a flow diagram illustrating finding a best quarter-pixel estimate point for a half-pixel estimate point in accordance with an embodiment of the present invention. FIG. 5 represents 304 of FIG. 3 in more detail. Each act of the method may be performed in hardware, software, or any combination thereof. Additionally, the ordering of the acts may be varied depending upon the implementation. Furthermore, it is not strictly necessary to save each interpolation, as the system may not need or want to re-use all of them. Lastly, one or more of the interpolations saved during this method can be re-used during other acts in the method, in addition to being able to be reused in subsequent methods.

At 500, a quarter-pixel point at a position quarter a pixel to the left of the best half-pixel estimate point may be interpolated, generating a ninth interpolation. At 502, the ninth interpolation may be saved. At 504, a quarter-pixel point at a position quarter a pixel to the right of the best half-pixel estimate point may be interpolated, generating a tenth interpolation. At 506, the tenth interpolation may be saved. At 508, a quarter-pixel point at a position quarter a pixel below the best half-pixel estimate point may be interpolated, generating an eleventh interpolation. At 508, the eleventh interpolation may be saved. At 512, a quarter-pixel point at a position quarter a pixel above the best half-pixel estimate point may be interpolated, generating a twelfth interpolation. At 514, the twelfth interpolation may be saved.

At 516, a quarter-pixel point at a position quarter a pixel below and quarter a pixel to the left of the best half-pixel estimate point may be interpolated, generating a thirteenth interpolation. At 518, the thirteenth interpolation may be saved. At 520, a quarter-pixel point at a position quarter a pixel below and quarter a pixel to the right of the best half-pixel estimate point may be interpolated, generating a fourteenth interpolation. At 522, the fourteenth interpolation may be saved. At 524, a quarter-pixel point at a position quarter a pixel above and quarter a pixel to the left of the best half-pixel estimate point may be interpolated, generating a fifteenth interpolation. At 526, the fifteenth interpolation may be saved. At 528, a quarter-pixel point at a position quarter a pixel above and quarter a pixel to the right of the best half-pixel estimate point may be interpolated, generating an sixteenth interpolation. At 520, the sixteenth interpolation may be saved.

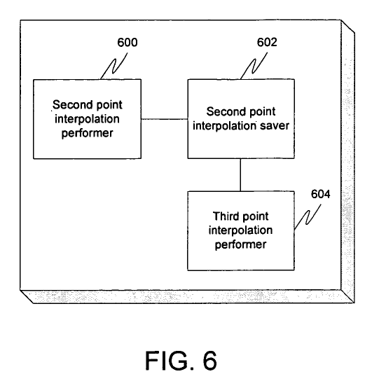

FIG. 6 is a block diagram illustrating an apparatus for performing motion estimation around a first point in an image in a video stream in accordance with an embodiment of the present invention. It should be noted that this apparatus may be used around any point in the image. Each element of this apparatus may be embodied in software, hardware, or any combination thereof. A second point interpolation performer 600 may perform interpolation to arrive at an estimated value of a second point that is a fraction of a pixel away from the first point, the performing generating a first set of results. The fraction of the pixel may be any fraction, and as discussed earlier, being a fraction of a pixel away from a point means that either the horizontal coordinate, vertical coordinate, or both vary from the point by the fraction.

A second point interpolation saver 602 coupled to the second point interpolation performer 600 may save the first set of results in a memory. A third point interpolation performer 604 coupled to the second point interpolation saver 602 may utilize the first set of results when performing interpolation to arrive at an estimated value of a third point. This utilization may occur at many different stages. For example, the third point may vary from the first point by the same fraction as the second point. Alternatively, the third point may vary a different point by the same fraction as the second point. Another possibility is that the third point may vary from either the first point or another point by a different fraction than the second point varied from the first point.

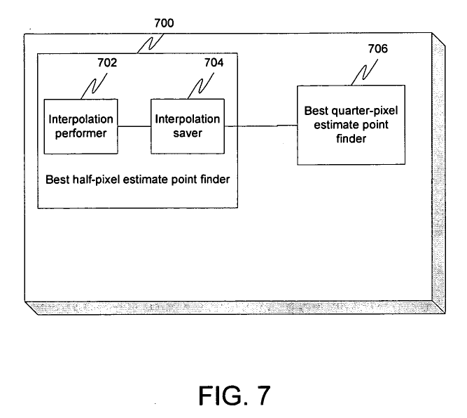

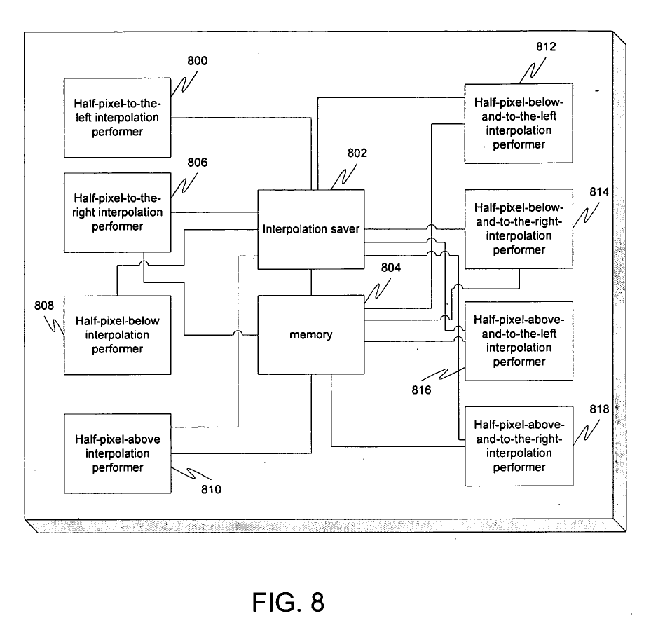

FIG. 7 is a block diagram illustrating an apparatus for performing motion estimation around a first integer point in an image in a video stream in accordance with another embodiment of the present invention. Each element of this apparatus may be embodied by software, hardware, or any combination thereof. In this embodiment, first half-pixel estimation is performed, followed by quarter-pixel estimation on the best half-pixel estimate point. Thus, a best half-pixel estimate point finder 700 may find a best half-pixel estimate point for the first integer point by performing interpolations for half-pixel points a half-pixel away from the first integer point and selecting the half-pixel point having the interpolation that is closest to a sample. The best half-pixel estimate point finder 700 may include an interpolation performer 702 and an interpolation saver 704. The interpolation saver 704 may save one or more of the interpolations performed by the interpolation performer. It should be noted that this saving may actually be performed during the finding of a best half-pixel estimate point, as will be seen in FIG. 8 and the accompanying text. Saving one or more of the interpolations during the finding allows the interpolations to be reused during other parts of the finding a best half-pixel estimate point. However, embodiments are possible where the interpolations from the finding of the half-pixel estimate point are not re-used during the finding of the half-pixel estimate point, and are only re-used during the finding of the best quarter-pixel estimate point.

A best quarter-pixel estimate point finder 706 coupled to the interpolation saver 704 may find a best quarter-pixel estimate point for the best half-pixel estimate point by performing interpolations for quarter-pixel points a quarter-pixel away from the best half-pixel estimate point and selecting the quarter-pixel point having the interpolation that is closest to sample. This may include utilizing the one or more saved interpolations from the half-pixel estimation and/or one or more saved interpolations during the finding of the best quarter-pixel estimate point.

FIG. 8 is a block diagram illustrating a best half-pixel estimate point finder in accordance with an embodiment of the present invention. FIG. 8 represents 700 of FIG. 7 in more detail. Each element of the best half-pixel estimate point finder may be performed in hardware, software, or any combination thereof. Additionally, the ordering of the acts may be varied depending upon the implementation. Furthermore, it is not strictly necessary to save each interpolation, as the system may not need or want to re-use all of them. Lastly, one or more of the interpolations saved during use of the best half-pixel estimate point finder can be re-used during other acts in the method, in addition to being able to be reused in subsequent methods.

A half-pixel-to-the-left interpolation performer 800 coupled to interpolation saver 802 may interpolate a half-pixel point at a position half a pixel to the left of the first integer point, generating a first interpolation. The first interpolation may be saved by a interpolation saver 802 in a memory 804. A half-pixel-to-the-right interpolation performer 806 coupled to the interpolation saver 802 and to the memory 804 may interpolate a half-pixel point at a position half a pixel to the right of the first integer point, generating a second interpolation. The second interpolation may be saved by the interpolation saver 802 in the memory 804. A half-pixel-below interpolation performer 808 coupled to the interpolation saver 802 and to the memory 804 may interpolate a half-pixel point at a position half a pixel below the first integer point, generating a third interpolation. The third interpolation may be saved by the interpolation saver 802 in the memory 804. A half-pixel-above interpolation performer 810 coupled to the interpolation saver 802 and to the memory 804 may interpolate a half-pixel point at a position half a pixel above the first integer point, generating a fourth interpolation. The fourth interpolation may be saved by the interpolation saver 802 in the memory 804.

A half-pixel-below-and-to-the-left interpolation performer 812 coupled to the interpolation saver 802 and to the memory 804 may interpolate a half-pixel point at a position half a pixel below and half a pixel to the left of the first integer point, generating a fifth interpolation. The fifth interpolation may be saved by the interpolation saver 802 in the memory 804. A half-pixel-below-and-to-the-right interpolation performer 814 coupled to the interpolation saver 802 and to the memory 804 may interpolate a half-pixel point at a position half a pixel below and half a pixel to the right of the first integer point, generating a sixth interpolation. The sixth interpolation may be saved by the interpolation saver 802 in the memory 804. A half-pixel-above-and-to-the-left interpolation performer 816 coupled to the interpolation saver 802 and to the memory 804 may be interpolated a half-pixel point at a position half a pixel above and half a pixel to the left of the first integer point, generating a seventh interpolation. The seventh interpolation may be saved by the interpolation saver 802 in the memory 804. A half-pixel-above-and-to-the-right interpolation performer 818 coupled to the interpolation saver 802 and to the memory 804 may interpolate a half-pixel point at a position half a pixel above and half a pixel to the right of the first integer point, generating an eighth interpolation. The eighth interpolation may be saved by the interpolation saver 802 in the memory 804.

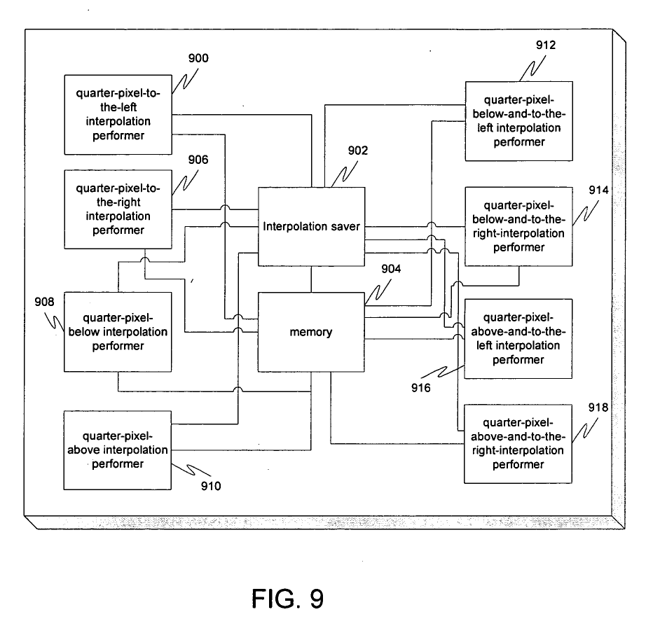

FIG. 9 is a block diagram illustrating a best quarter-pixel estimate point finder in accordance with an embodiment of the present invention. FIG. 9 represents 706 of FIG. 7 in more detail. Each element of the best quarter-pixel estimate point finder may be embodied in hardware, software, or any combination thereof. Additionally, the ordering of the acts may be varied depending upon the implementation. Furthermore, it is not strictly necessary to save each interpolation, as the system may not need or want to re-use all of them. Lastly, one or more of the interpolations saved during use of the best quarter-pixel estimate point finder can be re-used by the best quarter-pixel estimate point finder, in addition to being able to be reused in other components, if they exist.

A quarter-pixel-to-the-left interpolation performer 900 coupled to an interpolation saver 902 and to the memory 904 may interpolate a quarter-pixel point at a position quarter a pixel to the left of the best half-pixel estimate point, generating a ninth interpolation. The ninth interpolation may be saved by the interpolation saver 902 in a memory 904. A quarter-pixel-to-the-right interpolation performer 906 coupled to the interpolation saver 902 and to the memory 904 may interpolate a quarter-pixel point at a position quarter a pixel to the right of the best half-pixel estimate point, generating a tenth interpolation. The tenth interpolation may be saved by the interpolation saver 902 in the memory 904. A quarter-pixel-below interpolation performer 906 coupled to the interpolation saver 902 and to the memory 904 may interpolate a quarter-pixel point at a position quarter a pixel below the best half-pixel estimate point, generating an eleventh interpolation. The eleventh interpolation may be saved by the interpolation saver 902 in the memory 904. A quarter-pixel-above interpolation performer 908 coupled to the interpolation saver 902 and to the memory 904 may interpolate a quarter-pixel point at a position quarter a pixel above the best half-pixel estimate point, generating a twelfth interpolation. The twelfth interpolation may be saved by the interpolation saver 902 in the memory 904.

A quarter-pixel-below-and-to-the-left interpolation performer 910 coupled to the interpolation saver 902 and to the memory 904 may interpolate a quarter-pixel point at a position quarter a pixel below and quarter a pixel to the left of the best half-pixel estimate point, generating a thirteenth interpolation. The thirteenth interpolation may be saved by the interpolation saver 902 in the memory 904. A quarter-pixel-below-and-to-the-right interpolation performer 912 coupled to the interpolation saver 902 and to the memory 904 may interpolate a quarter-pixel point at a position quarter a pixel below and quarter a pixel to the right of the best half-pixel estimate point, generating a fourteenth interpolation. The fourteenth interpolation may be saved by the interpolation saver 902 in the memory 904. A quarter-pixel-above-and-to-the-left interpolation performer 914 coupled to the interpolation saver 902 and to the memory 904 may interpolate a quarter-pixel point at a position quarter a pixel above and quarter a pixel to the left of the best half-pixel estimate point, generating a fifteenth interpolation. The fifteenth interpolation may be saved by the interpolation saver 902 in the memory 904. A quarter-pixel-above-and-to-the-right interpolation performer coupled to the interpolation saver 902 and to the memory 904 may interpolate a quarter-pixel point at a position quarter a pixel above and quarter a pixel to the right of the best half-pixel estimate point, generating an sixteenth interpolation. The sixteenth interpolation may be saved by the interpolation saver 902 in the memory 904.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for performing motion estimation around a first point in an image in a video stream, the method comprising:
performing interpolation to arrive at an estimated value of a second point that is a fraction of a pixel away from the first point, said performing generating a first set of results;
saving said first set of results in a memory; and
utilizing said first set of results when performing interpolation to arrive at an estimated value of a third point.

2. The method of claim 1, wherein the second point is a half a pixel away from the first point and the third point is half a pixel away from the first point.

3. The method of claim 2, wherein the second point varies from the first point in only the negative horizontal direction and the third point varies from the first point in only the positive horizontal direction.

4. The method of claim 2, wherein the second point varies from the first point in only the negative vertical direction and the third point varies from the first point in only the positive vertical direction.

5. The method of claim 1, wherein the second point is half a pixel away from the first point and the third point is a quarter pixel away from a point a half a pixel away from the first point.

6. A method for performing motion estimation around a first integer point in an image in a video stream, the method comprising:
finding a best half-pixel estimate point for the first integer point by performing interpolations for half-pixel points a half-pixel away from the first integer point and selecting the half-pixel point having the interpolation that is closest to a sample;
saving one or more of said interpolations; and
finding a best quarter-pixel estimate point around the best half-pixel estimate point by performing interpolations for quarter-pixel points a quarter-pixel away from the best half-pixel estimate point and selecting the quarter-pixel point having the interpolation that is closest to a sample, wherein said finding a best quarter-pixel estimate includes utilizing the one or more saved interpolations.

7. The method of claim 6, wherein said finding includes:
interpolating a half-pixel point at a position a half a pixel to the left of the first integer point, generating a first interpolation;
saving the first interpolation;
interpolating a half-pixel point at a position a half a pixel to the right of the first integer point using the saved first interpolation, generating a second interpolation;
saving the second interpolation;
interpolating a half-pixel point at a position a half a pixel below the first integer point, generating a third interpolation;
saving the third interpolation;
interpolating a half-pixel point at a position a half a pixel above the first integer point using the saved third interpolation, generating a fourth interpolation;
saving the fourth interpolation;
interpolating a half-pixel point at a position half a pixel below and half a pixel to the left of the first integer point using the saved first interpolation and the saved third interpolation, generating a fifth interpolation;
saving the fifth interpolation;
interpolating a half-pixel point at a position half a pixel below and half a pixel to the right of the first integer point using the saved second interpolation, the saved third interpolation, and the saved fifth interpolation, generating a sixth interpolation;
saving the sixth interpolation;
interpolating a half-pixel point at a position half a pixel above and half a pixel to the left of the first integer point using the saved first interpolation, the saved fourth interpolation, and the saved fifth interpolation, generating a seventh interpolation;
saving the seventh interpolation;
interpolating a half-pixel point at a position half a pixel above and half a pixel to the right of the first integer point using the saved second interpolation, the saved fourth interpolation, the saved sixth interpolation, and the saved seventh interpolation, generating an eighth interpolation; and
saving the eighth interpolation.

8. An apparatus for performing motion estimation around a first point in an image in a video stream, the apparatus comprising:
a second point interpolation performer;
a second point interpolation saver coupled to said second point interpolation performer; and
a third point interpolation performer coupled to said second point interpolation saver.

9. An apparatus for performing motion estimation around a first integer point in an image in a video stream, the apparatus comprising:
a best half-pixel estimate point finder, said best half-pixel estimation point finder including an interpolation performer and an interpolation saver, wherein the interpolation saver is coupled to a memory; and
a best quarter-pixel estimate point finder coupled to said interpolation saver.

10. The apparatus of claim 9, wherein the best half-pixel estimate point finder interpolation performer includes:
a half-pixel-to-the-left interpolation performer coupled to the interpolation saver;
a half-pixel-to-the-right interpolation performer coupled to the memory and to the interpolation saver;
a half-pixel-below interpolation performer coupled to the interpolation saver;
a half-pixel-above interpolation performer coupled to the memory and to the interpolation saver;
a half-pixel-below-and-to-the-left interpolation performer coupled to the memory and to the interpolation saver;
a half-pixel-below-and-to-the-right interpolation performer coupled to the memory and to the interpolation saver;
a half-pixel-above-and-to-the-left interpolation performer coupled to the memory and to the interpolation saver; and
a half-pixel-above-and-to-the-right interpolation performer coupled to the memory and to the interpolation saver.

11. An apparatus for performing motion estimation around a first point in an image in a video stream, the apparatus comprising:
means for performing interpolation to arrive at an estimated value of a second point that is a fraction of a pixel away from the first point, said performing generating a first set of results;
means for saving said first set of results in a memory; and
means for utilizing said first set of results when performing interpolation to arrive at an estimated value of a third point.

12. The apparatus of claim 11, wherein the second point is a half a pixel away from the first point and the third point is half a pixel away from the first point.

13. The apparatus of claim 12, wherein the second point varies from the first point in only the negative horizontal direction and the third point varies from the first point in only the positive horizontal direction.

14. The apparatus of claim 12, wherein the second point varies from the first point in only the negative vertical direction and the third point varies from the first point in only the positive vertical direction.

15. The apparatus of claim 11, wherein the second point is half a pixel away from the first point and the third point is a quarter pixel away from a point a half a pixel away from the first point.

16. An apparatus for performing motion estimation around a first integer point in an image in a video stream, the apparatus comprising:
means for finding a best half-pixel estimate point for the first integer point by performing interpolations for half-pixel points a half-pixel away from the first integer point and selecting the half-pixel point having the interpolation that is closest to a sample;
means for saving one or more of said interpolations; and
means for finding a best quarter-pixel estimate point for the best half-pixel estimate point by performing interpolations for quarter-pixel points a quarter-pixel away from the best half-pixel estimate point and selecting the quarter-pixel point having the interpolation that is closest to a sample, wherein said finding a best quarter-pixel estimate includes utilizing the one or more saved interpolations.

17. The apparatus of claim 16, wherein said means for finding includes:
means for interpolating a half-pixel point at a position a half a pixel to the left of the first integer point, generating a first interpolation;
means for saving the first interpolation;
means for interpolating a half-pixel point at a position a half a pixel to the right of the first integer point using the saved first interpolation, generating a second interpolation;
means for saving the second interpolation;
means for interpolating a half-pixel point at a position a half a pixel below the first integer point, generating a third interpolation;
means for saving the third interpolation;
means for interpolating a half-pixel point at a position a half a pixel above the first integer point using the saved third interpolation, generating a fourth interpolation;
means for saving the fourth interpolation;
means for interpolating a half-pixel point at a position half a pixel below and half a pixel to the left of the first integer point using the saved first interpolation and the saved third interpolation, generating a fifth interpolation;
means for saving the fifth interpolation;
means for interpolating a half-pixel point at a position half a pixel below and half a pixel to the right of the first integer point using the saved second interpolation, the saved third interpolation, and the saved fifth interpolation, generating a sixth interpolation;
means for saving the sixth interpolation;
means for interpolating a half-pixel point at a position half a pixel above and half a pixel to the left of the first integer point using the saved first interpolation, the saved fourth interpolation, and the saved fifth interpolation, generating a seventh interpolation;
means for saving the seventh interpolation;
means for interpolating a half-pixel point at a position half a pixel above and half a pixel to the right of the first integer point using the saved second interpolation, the saved fourth interpolation, the saved sixth interpolation, and the saved seventh interpolation, generating an eighth interpolation; and
means for saving the eighth interpolation.

18. A program storage device readable by a machine, tangibly embodying a program of instructions executable by the machine to perform a method for performing motion estimation around a first point in an image in a video stream, the method comprising:
performing interpolation to arrive at an estimated value of a second point that is a fraction of a pixel away from the first point, said performing generating a first set of results;
saving said first set of results in a memory; and
utilizing said first set of results when performing interpolation to arrive at an estimated value of a third point.

19. A program storage device readable by a machine, tangibly embodying a program of instructions executable by the machine to perform a method for performing motion estimation around a first integer point in an image in a video stream, the method comprising:
finding a best half-pixel estimate point for the first integer point by performing interpolations for half-pixel points a half-pixel away from the first integer point and selecting the half-pixel point having the interpolation that is closest to a sample;
saving one or more of said interpolations; and
finding a best quarter-pixel estimate point for the best half-pixel estimate point by performing interpolations for quarter-pixel points a quarter-pixel away from the best half-pixel estimate point and selecting the quarter-pixel point having the interpolation that is closest to a sample, wherein said finding a best quarter-pixel estimate includes utilizing the one or more saved interpolations.
